(19) United States
(12) Patent Application Publication
(10) Pub. No.: US 2015/0247631 A1
(43) Pub. Date: Sep. 3, 2015

(54) METHOD OF CONVEYING HEAT FROM A LIGHT EMITTING DIODE ASSEMBLY

(71) Applicant: ONCE INNOVATIONS ,INC., Plymouth, MN (US)

(72) Inventors: Zdenko Grajcar, Orono, MN (US); John Lilly, Minneapolis, MN (US)

(21) Appl. No.: 14/429,887

(22) PCT Filed: Sep. 27, 2013
(86) PCT No.: PCT/US2013/062414

§ 371 Date: Mar. 20, 2015

Related U.S. Application Data
(60) Provisional application No. 61/707,313, filed on Sep. 28, 2012.

(51) Int. Cl. F21V 29/74; F21V 21/04

(52) U.S. Cl. CPC F21V 29/74; F21V 21/04

(57) ABSTRACT

A method of conveying heat from a light emitting diode assembly. The method includes providing a light emitting diode assembly having a body that has a substrate with driving circuitry and a plurality of light emitting diodes that produce heat that is conveyed to a heat transfer element. The heat transfer element has a continuously engaged interface with the ceiling of a dwelling when secured. In this manner heat is conveyed from the heat transfer element to the ceiling of the dwelling to dissipate heat from the assembly, thus presenting a light emitting diode assembly with a low profile.

### CROSS REFERENCE

This application claims benefit of priority to and is based upon U.S. Provisional Patent Application Ser. No. 61/707,313 filed Sep. 28, 2012, titled “Modular LED Lighting Assembly Utilizing Structures of a Dwelling as a Heat Sink,” which is hereby incorporated by reference herein in its entirety.

### BACKGROUND

This invention relates to light emitting diode (LED) Lighting Assemblies. More specifically this invention relates to modular LED lighting assemblies that utilize dwelling structures as a heat sink.

As energy costs have increased companies and individuals alike have begun looking for alternatives to the incandescent light bulb. One of the alternatives is LED lighting assemblies, that while currently more expensive to manufacture than an incandescent light bulb, between the cost saving in energy used to operate these light bulbs and the fact LED lighting assemblies simply last a significantly longer time than a typical incandescent light bulb, costs are offset. As manufacturing and design improvements continue to occur in the LED lighting assembly arts LED lighting assemblies continue to become a more economically viable alternative to the typical incandescent light bulb.

One of the main expenses in manufacturing an LED lighting assembly is associated with the heat sink. In particular, driving circuitry is used in order to control and operate the LEDs of an LED lighting assembly. Further, many LED lighting assemblies are placed in sockets that include dimming circuits, where the driving circuitry of the LEDs must additionally account for such circuits. Thus, while LEDs themselves only produce a minimum amount of heat, this driving circuitry, especially as current runs through such circuitry produces significant amounts of heat. In order to not overheat the circuitry large bulky heat sinks have had to be utilized to convey heat away from the circuitry. These heat sinks are not only bulky, but expensive to manufacture and design.

Most lighting assemblies are located on the ceiling or roofs of dwellings. While in some construction based applications ceilings and roofs are made out of heat insulated materials, other dwellings have roofs and ceilings made out of materials such as concrete or metal that will conduct heat.

For example, in agricultural settings there are many barns constructed worldwide that have lighting fixtures and electrical wiring adjacent or along a metal roof. In agricultural settings the cleanliness of a dwelling or barn is important in the breeding of animals such as chickens, turkeys, swine or the like. Typically, in environments where fowl such as chickens or turkeys are breed such dwellings or barns are thoroughly washed down and sprayed with disinfectant after each flock is removed. With the size of a typical heat sink, and with heat sinks typically having a finned design to convey heat, build up deposits can form therein. This build up can lead to potential viruses or diseases for the next flock and is undesirable. Such a result can potentially run afoul strict governmental biosecurity programs thus making consumers hesitate to purchase such LED lighting assemblies.

In another example in the construction of buildings made of concrete, often junction boxes are buried in the pour. As a result of the use of bulky heat sinks LED lighting assemblies simply extend out the junction boxes providing an undesirable aesthetic appearance. As a result, when replacing lighting in such buildings LED lighting assemblies simply are not even considered.

Thus, a need in the art exists for LED lighting assemblies that eliminate the use of bulky heat sinks. In addition a need in the art exists for a LED lighting assembly that is inexpensive to manufacture and easy to install.

Therefore a principle object of the present invention is to minimize the size of an LED lighting assembly;

Yet another object of the present invention is to reduce manufacturing costs of assembling LED lighting assemblies; and

Another object of the present invention is to facilitate installation of an LED lighting assembly;

These and other object, features and advantages will become apparent from the rest of the specification.

### SUMMARY OF THE INVENTION

An LED lighting assembly that utilizes a substrate containing electrical components the drive a plurality of LEDs. The substrate is connected to a heat transfer element such that heat is transferred from the LEDs and electrical components, through the substrate, to the heat transfer element to a structure in or of a dwelling. In one embodiment the heat transfer element is secured to a roof of a dwelling transferring heat to the roof. In a second embodiment the heat transfer element is connected to a ceiling of a dwelling and heat is transferred to the ceiling.

### BRIEF DESCRIPTION OF THE DRAWINGS

FIG. 1 is a perspective view of an LED lighting assembly;

FIG. 2 is a bottom perspective view of an LED lighting assembly;

FIG. 3 is a side plan view of an LED lighting assembly;

FIG. 4 is a schematic diagram of circuitry of an LED lighting assembly;

FIG. 5 is a perspective view of an end cap of an LED lighting assembly;

FIG. 6 is a side plan view with hidden lines of an LED lighting assembly in a dwelling;

FIG. 7 is a front plan view of an LED lighting assembly;

FIG. 8 is a back plan view of an LED lighting assembly;

FIG. 9 is a front perspective view of an LED lighting assembly including a lens element;

FIG. 10 is a front plan view of an LED lighting assembly; and

FIG. 11 is a side plan view with hidden lines of an LED lighting assembly in a dwelling.

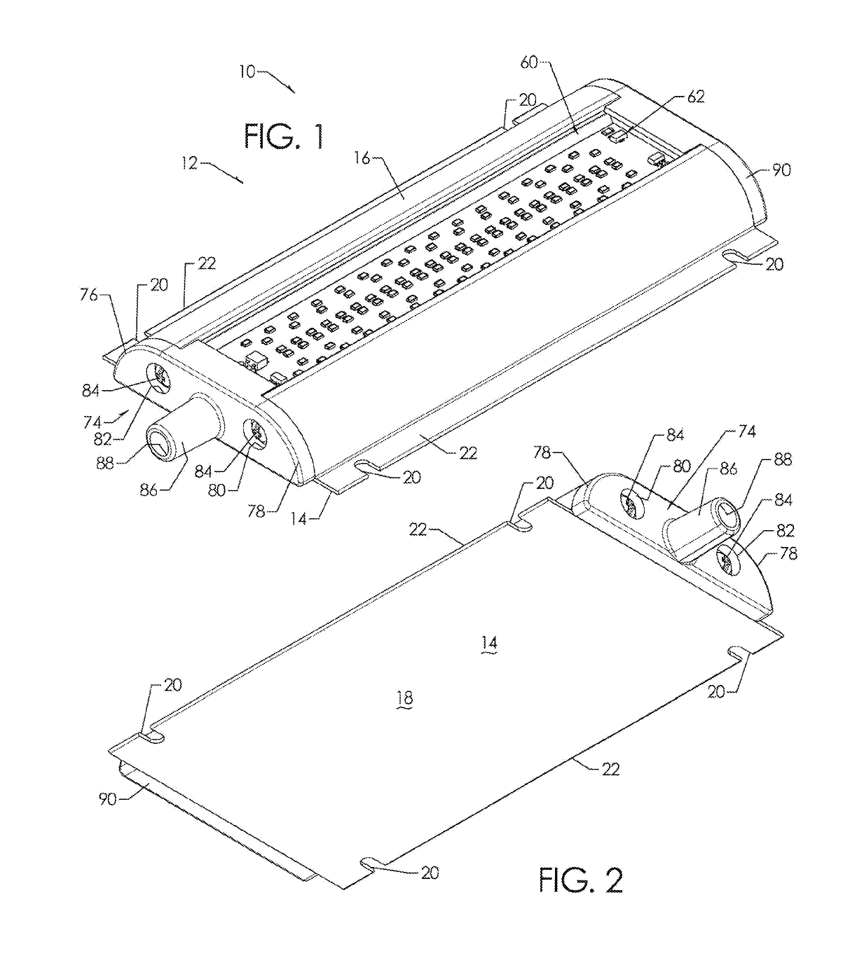

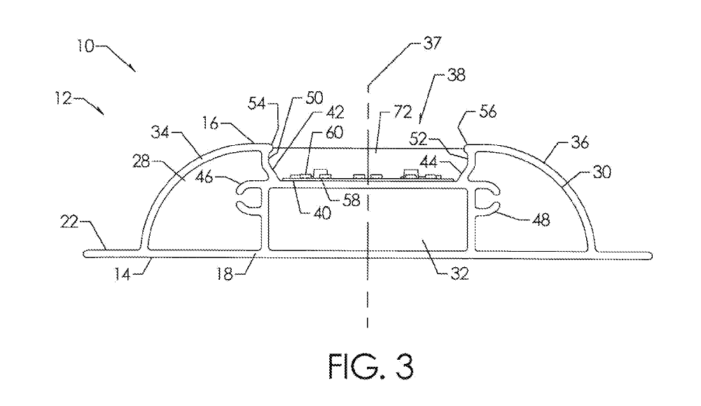

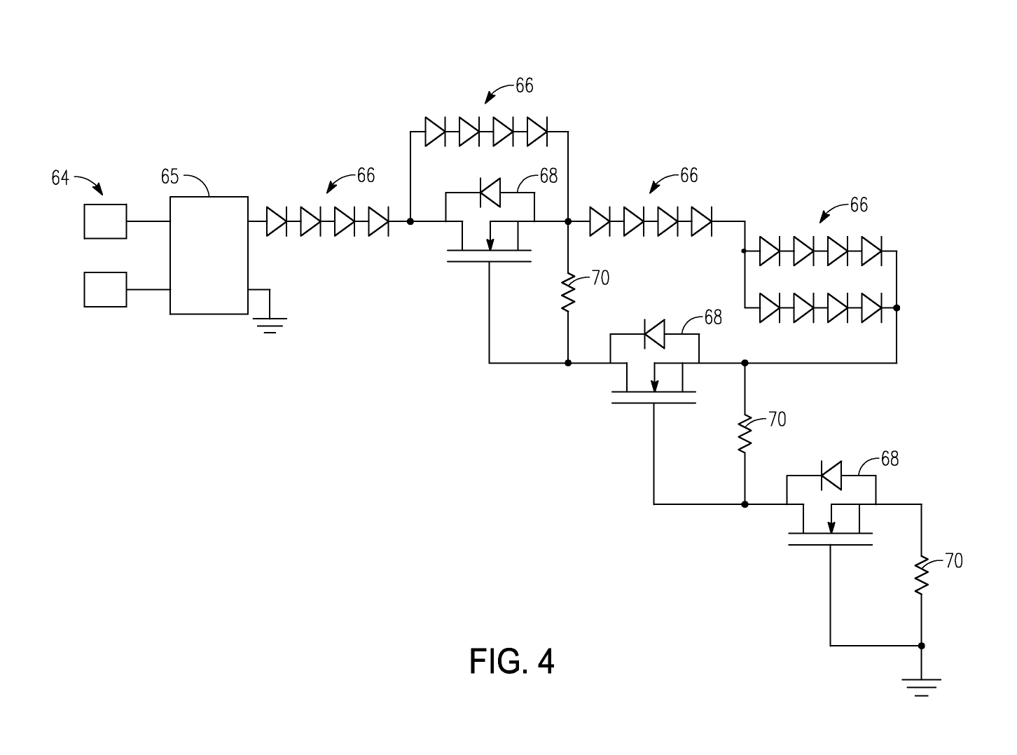

### DETAILED DESCRIPTION OF A PREFERRED EMBODIMENT

In a first embodiment the figures show a light emitting diode assembly 10 having a body 12 that extends from a bottom 14 to a top 16. At the bottom 14 is a heat transfer element 18 that in a preferred embodiment is generally rectangular in shape, continuous and flat, running the length of the body 12. The heat transfer element has a plurality of slots 20 disposed through flanges 22 that extend from the body 12. The slots 20 receive fastening elements such that the body 12 can be secured to a roof 24 of a dwelling 26 in such a way that the heat transfer element 18 engages the roof 24. Preferably the entire heat transfer element 18, when secured, completely engages the roof 24 continuously, without interruption along the entire length of the body 12 to form a heat transferring interface between the heat transfer element 18 and roof 24. In one embodiment the dwelling 26 is a barn and the roof 24 is made of metal.

A plurality of cavities 28, 30 and 32 are disposed through the body 12 with arcuate sidewalls 34 and 36 that extend from the flanges 22 toward a central axis 37 enclosing the first and second outer cavities 28 and 30. The design of the cavities 28, 30 and 32 provide ease in manufacturing and make the body 12 light weight and easy to handle during the installation process. The cavities 28, 30 and 32 also allow electrical wiring 39 to be stored therein. By having the arcuate sidewalls 34 and 36 a low profile is provided, decreasing the overall size of the body 12 and providing an assembly 10 specifically contoured to withstand high pressure washing as is typical in an agricultural environment.

A recess 38 is disposed centrally within the body and extends along the entire length of the body 12. Defining the recess 38 is a first surface 40 centrally located within the body 12 and terminating in first and second angled edges 42 and 44. First and second pockets 46 and 48 are disposed in the first and second outer cavities 28 and 30 adjacent the first and second angled edges 42 and 44 to provide opening for receiving fasteners. The first and second angled edges 42 and 44 symmetrically extend upward, away from the first surface 40 and central axis 37 and terminate in first and second sidewalls 50 and 52. The first and second sidewalls 50 and 52 terminate in first and second flange elements 54 and 56 that extend from and away from the arcuate sidewalls 34 and 36.

A substrate 58 of size and shape to fit snugly within the recess 38 is also provided. In one embodiment the substrate is generally rectangular. In a preferred embodiment the substrate 58 is a printed circuit board (PCB). The substrate 58 is populated with a plurality of electrical components 60.

In one embodiment the electrical components 60 include driving components 62 for receiving electricity from an AC input 64. In one embodiment the AC input provides 120 VAC whereas in another embodiment 230 VAC is provided. In a preferred embodiment the current is conditioned as taught in US Pat. Publ. No. 2011/0210678 entitled Spectral Shift Control for Dimmable AC LED Lighting to Grajcar that is incorporated entirely herein. Specifically, electricity from the AC input 64 is received by a rectifier 65 begins conditioning the AC current for a plurality of light emitting diodes 66. The current supplied to the light emitting diodes 66 is further conditioned by a plurality of transistors 68 and resistors 70. Preferably the transistors in one embodiment are MOSFETs, in other embodiments IGFET or other similar transistors are utilized. In addition, protection components such as fuses, MOVs and the like can be populated on the substrate 58.

In one embodiment the driving components 62 and light emitting diodes 66 operate to provide light output at predetermined wavelengths or colors associated with enhancing a physiological characteristic or create a predetermined psychological reaction in an animal or growth characteristic of a plant. To this end the assemblies 10 provide light output consistent with at least lighting spectrums as disclosed in US Pat. Publ. No. 2011/0228515 entitled Light Sources Adapted to Spectral Sensitivity of Diurnal Avians and Humans, US Pat. Publ. No. 2011/0101883 entitled LED Lighting for Livestock Development; US Pat. Publ. No. 2012/0186524 entitled Differential Illumination to Select Egg Laying Sites; PCT Appl. No. PCT/US2013/058511 entitled Symbiotic Shrimp and Algae Growth System; PCT Appl. No. PCT/US2013/049708 entitled Light Sources Adapted to Spectral Sensitivity of Plants; U.S. application Ser. No. 14/033,252 entitled Light Sources Adapted to Spectral Sensitivity of Diurnal Avians and Humans; U.S. application Ser. No. 13/715,904 entitled Aquaculture Lighting Devices and Methods; and U.S. Appl. Ser. No. 61/861,645 entitled System and Method for Manipulating Psychological and Physiological Characteristics of Swine, all to Grajcar and all of which are incorporated entirely herein.

An epoxy 72 or other clear waterproofing material is filled within the recess 38 to thus protect the electrical components 60 while allowing light emitted by the LEDs 66 to illuminate the interior of the dwelling 26. Specifically the epoxy 72 fills the recess with the flange elements 54 and 56 defining to top of the fill. Once dried the epoxy 72 forms a water proof seal preventing water from contacting the substrate 58 during the cleaning operation.

To further waterproof the assembly 10 a first end cap 74 is provided that is of size and shape to slidably mount into the body 12. The end cap 74 includes arcuate edges 76 and 78 that mate and engage with the arcuate sidewalls 34 and 36. Openings 80 and 82 are disposed therethrough such that fasteners 84 can be disposed therethrough and tightened into first and second pockets 46 and 48 to form a sealing connection between the cap 74 and the body 12, again providing water proofing. An overmold element 86 extends from the first end cap 74 and has an opening 88 disposed therethrough for receiving wiring from a conduit or other means within the dwelling 26. The wiring can then be overmolded to provide a sealing connection between the wiring and assembly 10 such that again water is prevented from reaching the wiring or substrate 58. While an overmold element 86 is shown, any type of waterproof wiring connection known in the art can be used without falling outside the scope of this disclosure.

A second end cap 90 is also secured to the body 12 similar to the first end cap 74. Again, the second end cap prevents water from reaching the wiring and substrate 58 during washing of the lighting assembly 10.

In operation wiring from a dwelling 26 is disposed through the overmold element 86 and the overmold element 86 is overmolded over the wiring to provide a water proof connection between the wiring and assembly 10. The wires are then electrically connected to the substrate 58 and the end caps 74 and 90 secured to the body 12 to form a water tight enclosure. The heat transfer element 18 is then completely and continuously engaged against the roof 24 of dwelling 26 and secured thereto by securing fasteners through the slots 20 in flanges 22.

Once electricity (AC or DC) is supplied through the wiring the driving components 62 of the electrical components 60 on the substrate 58 power the LEDs 66 to illuminate the dwelling 26. As current runs through the electrical components, heat from the components 60 is dissipated through the substrate, to the body 12 to the heat transfer element 18. The heat transfer element 18 then transfers the heat to the roof 24 of the dwelling 26. In this manner the roof 24 acts as a heat sink for the lighting assembly.

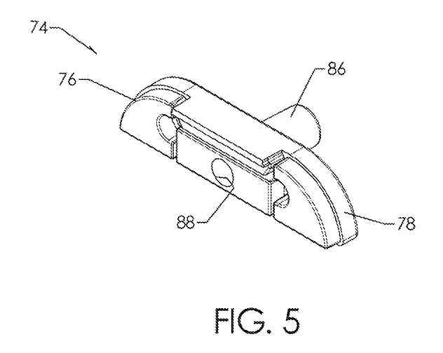

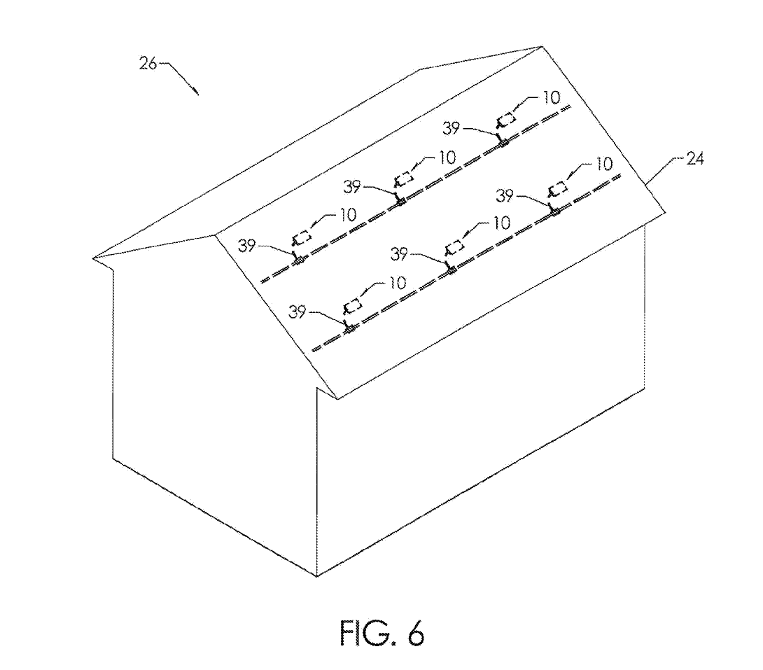

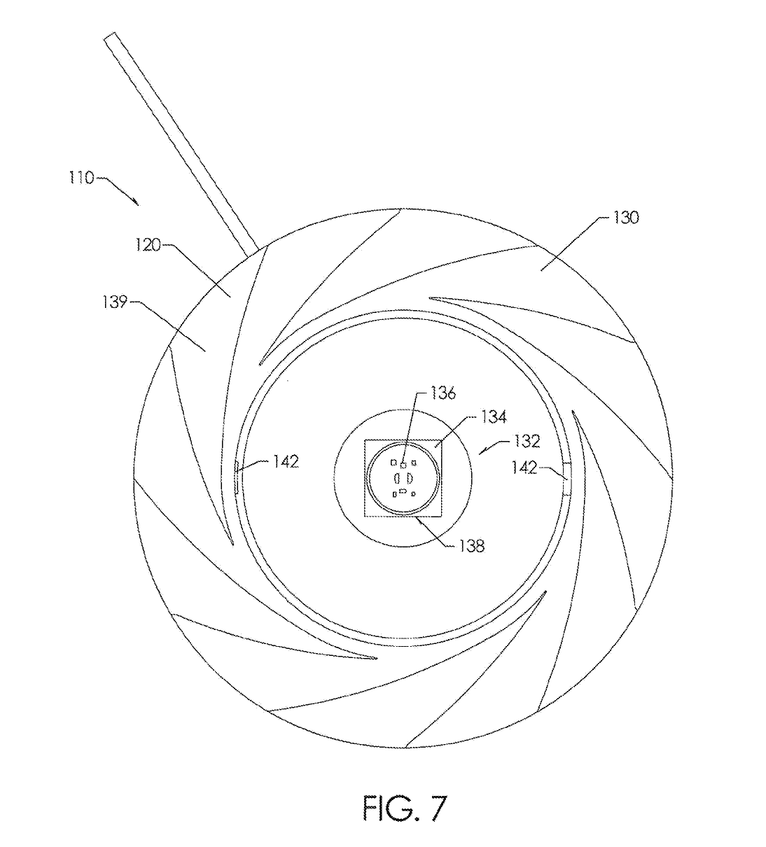

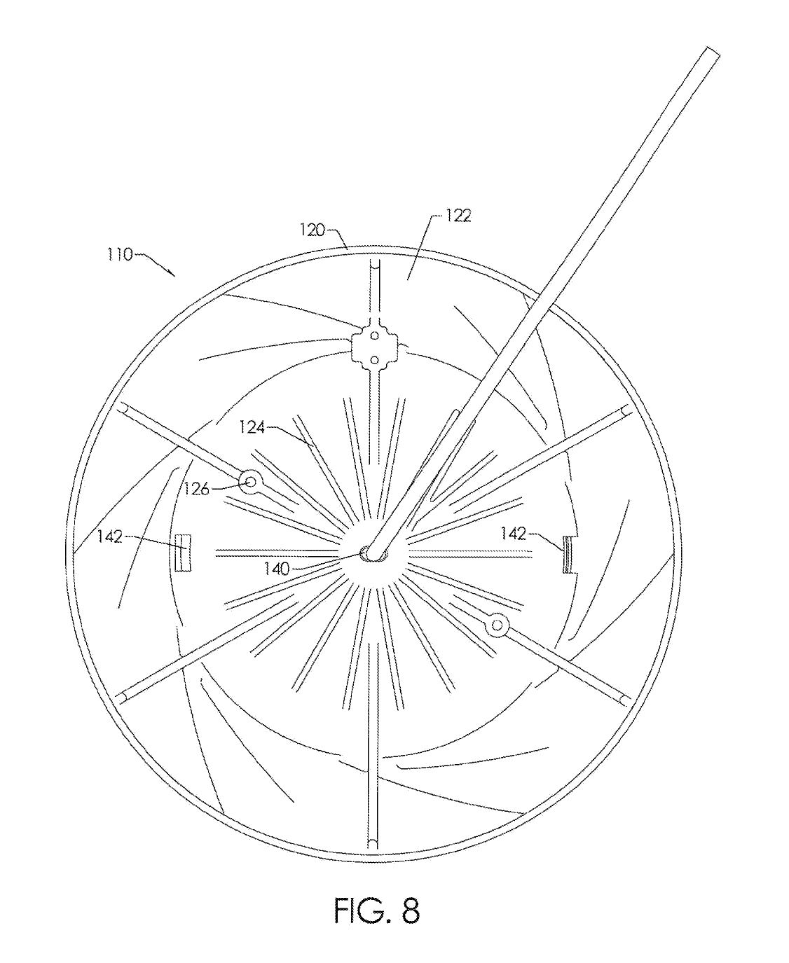

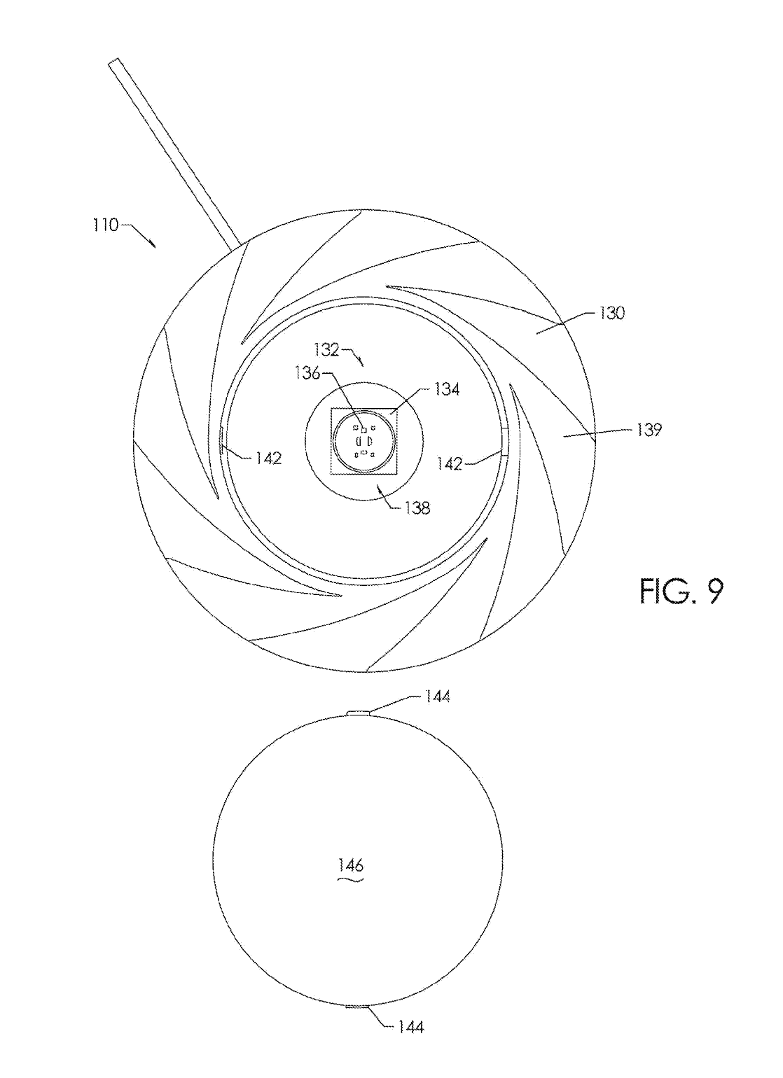

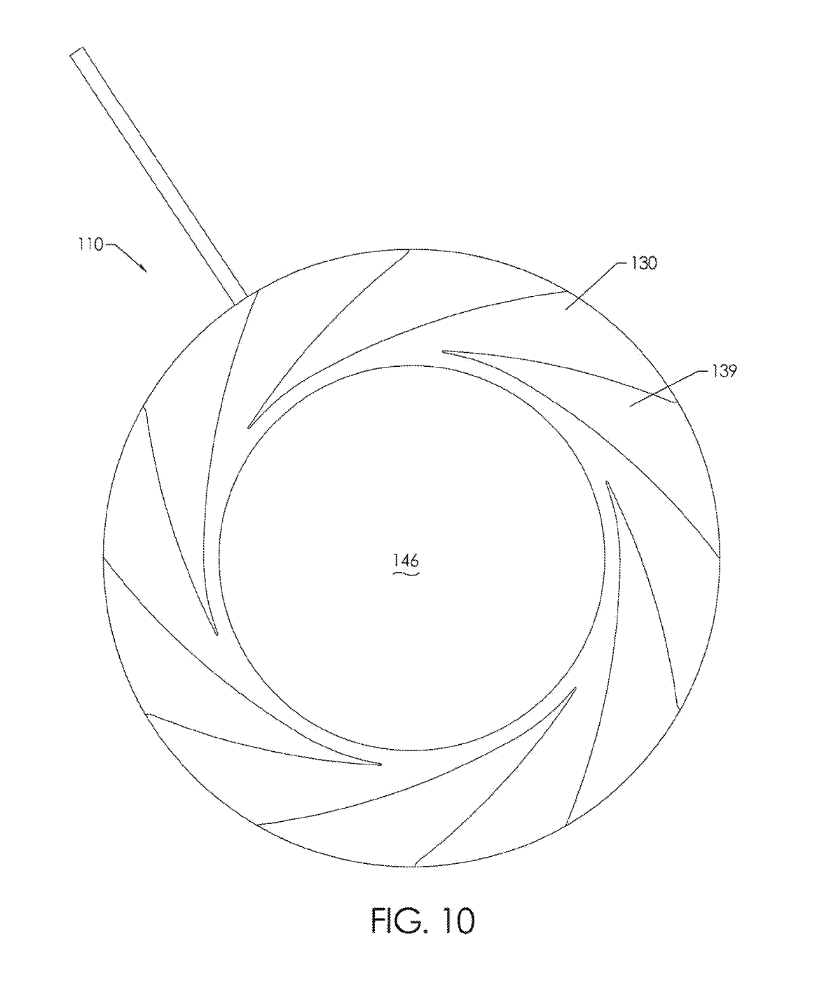

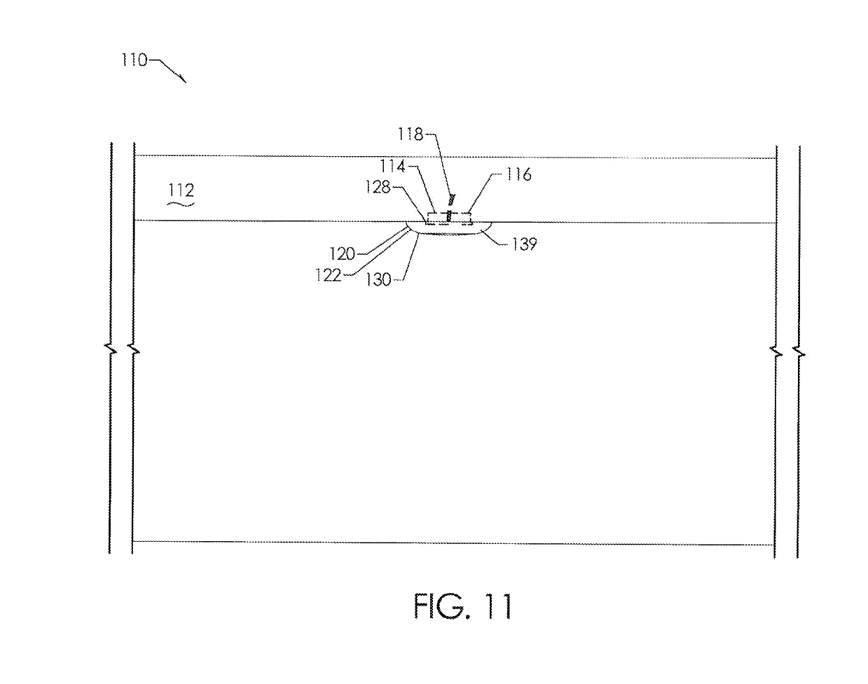

In an alternative embodiment as shown in FIGS. 5-7, a similar lighting assembly 110 is provided where the dwelling 26 is a building having a ceiling 112. The ceiling 112 in one embodiment is made of concrete. The ceiling 112 has an opening 114 that optionally has a junction box 116 and wiring 118 disposed therethrough. The lighting assembly 110 comprises a heat transfer element 120 that in one embodiment is generally round with a low profile having a back surface 122 that has a plurality of rib elements 124 to assist in conveying heat. The back surface 122 also has openings 126 for fasteners to attach to a mounting plate 128 to connect to the junction box 116, directly to the ceiling 112 or otherwise.

The front surface 130 of the heat transfer element 120 has a decorative exterior that is aesthetically pleasing and can be designed to appear as a downlight. The front surface 130 additionally has a recess 132 that receives a substrate 134 containing electrical components 136 and LEDs 138 as described in the first embodiment above and as fully described in U.S. patent application Ser. No. 13/585,806 entitled Light Emitting System to Grajcar that is incorporated entirely herein. As a result of utilizing the substrate 134 described therein the LEDs 138 are flush or even with the ceiling such that a heat transfer element 120 can hold the substrate and provide any external appearance. In particular, the outside of the decorative exterior in one embodiment has a detachable ring 139 wherein the design of the ring, including colors, trim and the like can be altered to provide different appearances to a user without removing the substrate. Alternatively the assembly 110 can be mounted on other surfaces, such as a deck, a swimming pool or waterway wall, an exterior wall of a dwelling, outdoor landscaping, an interior wall or the like. In each embodiment the low profile provides an aesthetically pleasing appearance while allowing heat transfer to the structure upon which the assembly is mounted.

A central opening 140 is disposed through the heat transfer element 120 so that the wiring 118 is disposed therethrough to provide an electrical connection to the substrate 134. Slots 142 are also disposed therethrough such that tabs 144 of a lens element 146 can snap into place to cover the LEDs 138 and optionally diffuse light.

In operation when a lighting assembly 110 is desired, wiring 118 disposed through an opening 114 in the ceiling 112 is electrically connected to the substrate 138 that is connected to the heat transfer element 120. The heat transfer element 120 is then secured to a junction box 116 or directly to the ceiling 112 either with a mounting plate 128 or otherwise. Because the heat transfer element 120 has a low profile, the heat transfer element is able to completely cover the opening 114 and optionally the junction box 116 such that the assembly 110 does not have to be perfectly installed and can be offset from the opening 114 without altering the aesthetic appearance of the dwelling 26. In this manner installation of the assembly is facilitated.

In use, heat from the LEDs 138 and electrical components 136 is then conveyed from the substrate 138 to the heat transfer element 120 to either the junction box 116, then to the ceiling 112 or alternatively straight to the ceiling 112. In this manner the ceiling 112 acts as a heat sink again allowing a more compact and low profile lighting assembly.

Unlike incandescent light bulbs, because LEDs 138 can operate for years without burning out the detachable ring 139 can be removed and replaced to change the style of light. Thus a dwelling 26 may be updated without the need to replace the entire lighting assembly 110.

Thus presented are lighting assemblies 10, 110 that utilize a structure of a dwelling such as a roof 24 or ceiling 112 as a heat sink. In this manner the size of the LED based lighting assembly 10 or 110 is greatly reduced, manufacturing costs are minimized and the assemblies 10, 110 can be utilized in multiple applications. Thus at the very least, all of the stated objects of the present invention have been met.

1. A method of conveying heat from a light emitting diode assembly, steps comprising:
providing a light emitting diode assembly having a body with a continuously extending heat transfer element,
securing a substrate having driving circuitry and a plurality of light emitting diodes thereon to the body to convey heat from the driving circuitry to the heat transfer element;
forming a continuously engaged interface along the entire length of the body between the heat transfer element and a ceiling of a dwelling when securing the light emitting diode assembly to the ceiling of the dwelling; and
conveying heat from the heat transfer element to the ceiling of the dwelling to dissipate heat from the assembly.

2. The method of claim 1 wherein the entire bottom surface of the heat transfer element engages the ceiling of the dwelling.

3. The method of claim 2 wherein the heat transfer element is flat, running the length of the body.

4. The method of claim 2 wherein the heat transfer element extends past the body to form flanges for securing the light emitting diode assembly to the ceiling of a dwelling.

5. The method of claim 1 wherein the body has at least one cavity therein with electrical wiring disposed threthrough.

6. The method of claim 1 wherein the dwelling is a barn.

7. The method of claim 1 wherein the ceiling is a metal roof.

8. The method of claim 1 wherein the body has a recess disposed therein that receives the substrate.

9. The method of claim 8 further comprising the step of filling the cavity with epoxy to provide a waterproof seal to prevent water from contacting the substrate.

10. The method of claim 9 wherein substantially all of the heat created by the driving circuitry is conveyed to the ceiling of the dwelling.

11. A method of conveying heat through a low profile, decorative, light emitting diode assembly, step comprising:
providing a substrate having a plurality of light emitting diodes and driving circuitry;
securing the substrate to a front surface of a heat transfer element wherein the substrate lies on a single plane and engages the heat transfer element;
said heat transfer element having a decorative exterior that surrounds the substrate to convey heat from the substrate.

12. The method of claim 11 wherein the decorative exterior that surrounds the substrate is a detachable and replaceable ring having a predetermined design that is replaceable without removal of the substrate.

13. The method of claim 11 wherein the heat transfer element has a back surface with a plurality of rib elements that convey heat from the substrate to the decorative exterior.

14. The method of claim 11 further comprising the step of securing a lens element to the heat transfer element to cover the light emitting diodes of the substrate and diffuse light.

15. The method of claim 11 further comprising the step of securing the light emitting diode assembly against the ceiling of a dwelling and conveying heat from the substrate, through the heat transfer element to the ceiling.
